(19) United States
(12) Patent Application Publication
(10) Pub. No.: US 2003/0169922 A1
(43) Pub. Date: Sep. 11, 2003

(54) Image data processor having image-extracting function

(75) Inventor: Seiichi Kamon, Kato-gun (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/366,412

(22) Filed: Feb. 14, 2003

(30) Foreign Application Priority Data
Mar. 5, 2002 (JP) 2002-58411

(51) Int. Cl. G06K 9/34

(52) U.S. Cl. 382/173

(57) ABSTRACT

A data processor is provided with a database consisting of individual pieces of image data, a storage that stores area-specifying data to specify part of each individual piece of the image data, and an editor that extracts partial image data from each individual piece of image data in accordance with the area-specifying data.

### BACKGROUND OF THE INVENTION

1. Field of the Invention

The present invention relates to an image data processor having an automatic image-extracting function. It also relates to a computer program used for image data management.

2. Description of the Related Art

Conventionally, various types of image management software are developed for use in a personal computer, for example. One of the functions of image management software is the management of a database, or a large amount of information stored in the computer. With the image management software installed, “thumbnail” pictures or photographs of the original images incorporated from a scanner or a digital camera can be automatically displayed on the monitor, which is very convenient for the computer user to browse through or rearrange the collected data in the database.

According to the conventional thumbnail display scheme, however, the entirety of the original information-carrying medium is subjected to size reduction, as shown in FIG. 8 of the accompanying drawings. Thus, the displayed letters or signs printed on the original medium are often too small to be read.

### SUMMARY OF THE INVENTION

The present invention has been proposed under the circumstances described above. It is, therefore, an object of the present invention to provide a data processor with which image data management for realizing readable list display or print can be readily performed.

According to a first aspect of the present invention, there is provided a data processor comprising: a database including individual pieces of image data; a storage that stores area-specifying data to specify part of each individual piece of the image data; and an editor that extracts partial image data from each individual piece of the image data in accordance with the area-specifying data.

Preferably, the area-specifying data may include area-specifying parameters that are common for all the individual pieces of the image data.

Preferably, the area-specifying data may include a plurality of area-specifying parameter sets each corresponding to one of the individual pieces of the image data.

Preferably, the area-specifying data may comprise a parameter for specifying a point of an extraction area and a parameter for specifying a size of the extraction area.

Preferably, the area-specifying data may be produced by the editor based on the image data included in the database.

Preferably, the editor may be provided with a recognition function for a particular color, and wherein the image data included in the database comprises information on the particular color.

Preferably, the editor may be provided with a recognition function for a particular configuration, and wherein the image data included in the database comprises information on the particular configuration.

Preferably, the editor may be provided with a recognition function for a particular letter, and wherein the image data included in the database comprises information on the particular letter.

Preferably, the area-specifying data for the image data may comprise area-specifying parameters for specifying at least two different areas.

Preferably, the editor may subject the extracted partial image data to size reduction.

Preferably, the area-specifying data stored in the storage may be recursive for a newly-input individual piece of image data.

According to a second aspect of the present invention, there is provided a computer program for executing the procedures of: storing area-specifying data to specify part of image data stored in a database; and extracting partial image data from the image data in the database based on the area-specifying data. other features and advantages of the present invention will become apparent from the detailed description given below with reference to the accompanying drawings.

### BRIEF DESCRIPTION OF THE DRAWINGS

FIG. 1A shows a data processor according to a first embodiment of the present invention;

FIG. 1B illustrates area-specifying parameters, x, xl, y and yl for defining the area or section to be extracted from a flier for partial display;

FIG. 1C shows two marks put on the flier for indication of the section to be extracted for partial display;

FIG. 2 shows a flow chart of a collective display procedure of the first embodiment;

FIG. 3 shows a data processor according to a second embodiment of the present invention;

FIG. 4 shows a flow chart of a collective display procedure of the second embodiment;

FIG. 5 shows a data processor according to a third embodiment of the present invention;

FIG. 6 is a flow chart of a collective display procedure of the third embodiment;

FIG. 7 illustrates an example of section extraction; and

FIG. 8 illustrates a conventional data display procedure.

### DETAILED DESCRIPTION OF THE PREFERRED EMBODIMENT

Preferred embodiments of the present invention will be described below with reference to the accompanying drawings.

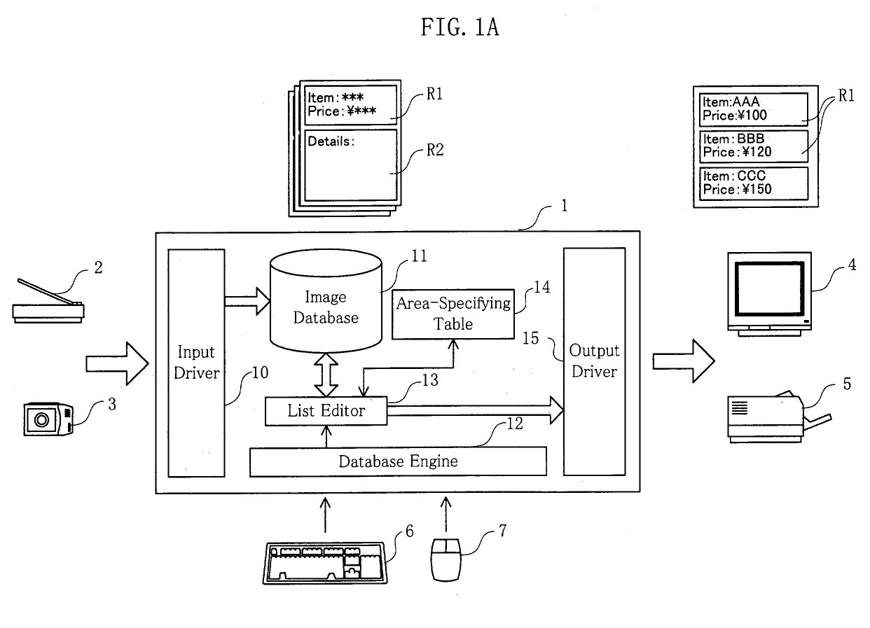

FIG. 1A is a schematic view showing an image data processor 1 according to a first embodiment of the present invention. The processor 1 may be realized by a personal computer equipped with image data control software composed of programs or data such as an input driver 10, an image database 11, a database engine 12, a list editor 13, a area-specifying table or storage 14, and an output driver 15. For performing a required operation, the processor 1 may be connected to a scanner 2, a digital camera 3, a monitor 4, a printer 5, a keyboard 6 and a mouse 7. As hardware, these devices 1-7 are conventional ones. Thus, the following description is mainly given to the software aspects of the present invention.

The input driver 10 receives image data supplied from the scanner 2 or the digital camera 3.

The image database 11 may comprise a large amount of image data collected in an organized way that allows individual pieces of information to be found quickly. In the example shown in FIG. 1A, the collected image data represent fliers (handbills), that advertise commercial goods. Each flier may be divided into two or more sections in accordance with the predetermined layout. The flier shown in FIG. 1A has two sections or areas R1 and R2, the former allotted for the product's name and the price, the latter allotted for the relevant details of the product.

The database engine 12 searches image data from the database 11 and regulates the database 11.

The list editor 13 supports the database engine 12. Specifically, when the user requires the searching of image data, the list editor 13 automatically extracts data from the database 11 so that the identical sections of the respective fliers will be displayed or printed. In the example shown in FIG. 1A, data representing the sections R1 of the respective computerized fliers is extracted for output to the monitor 4 or the printer 5. The setting of the section to be extracted from the fliers may be performed by the user. Specifically, the user may type in section-specifying data through the keyboard 6. As seen from FIG. 1B, the section-specifying data may be geometric data, such as x=10 mm, y=20 mm, xl=50 mm and yl=30 mm, where x and y in combination signify the starting point (the upper-left point in the figure) of the region, xl signifies the horizontal size of the region, and yl signifies the vertical size of the region. Instead of typing in the geometric data, the user may specify the desired rectangular region on-screen by using the mouse 7. In this case, the user brings the on-screen cursor to the desired point (beginning of the desired region), and clicks on the left mouse button. Then, keeping the button held down, the user drags the mouse to move the cursor diagonally to the end of the desired region. Finally, the user releases the button.

The area-specifying data inputted by the user is stored in the area-specifying table 14. The area-specifying data of the first embodiment is composed of one set of parameters which are common for all the fliers of the same layout and the same size.

The output driver 15 forwards the image data supplied from the list editor 13 to the monitor 4 or the printer 5.

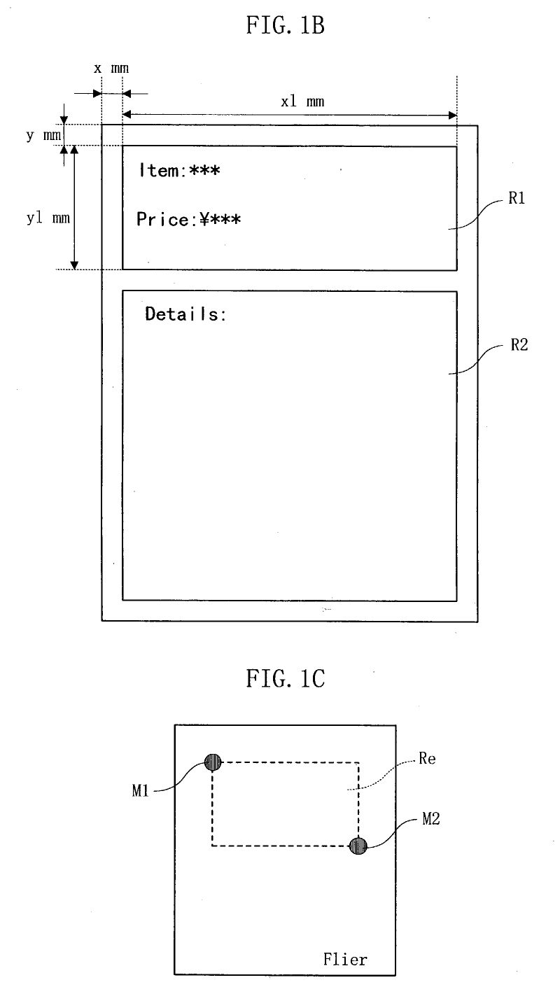

Referring to the flow chart shown in FIG. 2, a list display process based on the extracted image data will now described.

When the user selects the image data search mode, the list editor 13 reads out the image data from the database 11. The read-out data contains individual pieces of data that correspond to fliers. Then, the editor 13 performs data extraction with respect to the individual pieces of data in accordance with the common area-specifying data stored in the table 14 (S1). Then, the editor 13 organizes or arrays the extracted pieces of data (S2) for realization of arrayed display of the data. Finally, the data is sent to the monitor 4 (and/or the printer 5) via the output driver 15. Thus, as shown in FIG. 1A, the selected sections of several fliers are displayed on the monitor 4 (S3). Since only a part of each flier is displayed, relatively large space is provided for each on-screen item, though several items appear simultaneously on the screen. Thus, the displayed message can be large enough to enable the user to easily read.

To view the details of an item, the user may click on the displayed section of the particular item, so that the hidden information will appear on the monitor 4.

In the above embodiment, it is the user who performs the inputting of the four area-specifying parameters (x, xl, y, yl) required for extraction of the desired information. Preferably, this input task may be performed automatically. One possible way to achieve this is that the list editor 13 is provided with a color recognition function for a particular color (e.g., red). Correspondingly, the information to be extracted from the flier is printed in this particular color (red). The other information may be printed in black. In this situation, the flier is scanned by the scanner 2, and all the read-out image information is sent to the database 11 via the input driver 10 for data storage. Thereafter, the list editor 13 analyzes the stored image data of the flier to determine where the information to be extracted (which is originally printed in red) is located in the flier. Specifically, based on the image data stored in the database 11 and employing the color recognition function, the list editor 13 works out the four parameters (x, xl, y and yl as shown in FIG. 1B) needed for specifying the position and size of the rectangular region in which the red-printed information is contained. The calculated parameters are automatically written to the area-specifying table 14.

In place of the above color recognition function, the list editor 13 may be provided with a geometric pattern recognition function for figures, letters, pictures, etc. In this case, the list editor 13 recognizes a particular pattern printed on the flier, based on the image data stored in the database 11, and works out the area-specifying parameters of the rectangular region containing the particular pattern.

When the list editor 13 has a color or pattern recognition, use may be made of two marks printed on the flier, as shown in FIG. 1C, for specifying the region to be extracted. A first mark M1 is put for indicating the beginning of the region to be extracted (Re), while a second mark M2 is put for indicating the end of the region. The second mark M2 is located diagonally, below and to the right of the first mark M1. The marks M1, M2 are drawn in erasable material so that they can be removed with an eraser after the scanning of the flier is over. When the list editor 13 has a color recognition function, the marks M1, M2 are accordingly colored.

It is possible to put only a single mark on the flier for defining the region to be extracted from the flier. The mark may be the one to show the beginning of the region, like the mark M1 shown in FIG. 1C. In this case, the horizontal and vertical sizes of the region to be extracted can be specified by two parameters like xl and yl shown in FIG. 1B.

The above-described marks may be drawn on a transparent sheet, but not on a flier. When the flier is subjected to image scanning, the marked transparent sheet is placed over the flier, to be disposed between the flier and the scanner.

The mark may be drawn on a seal to be attached to the flier or the transparent sheet.

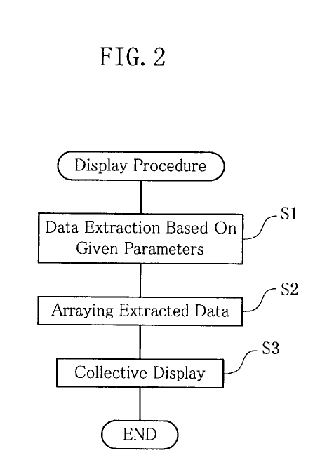

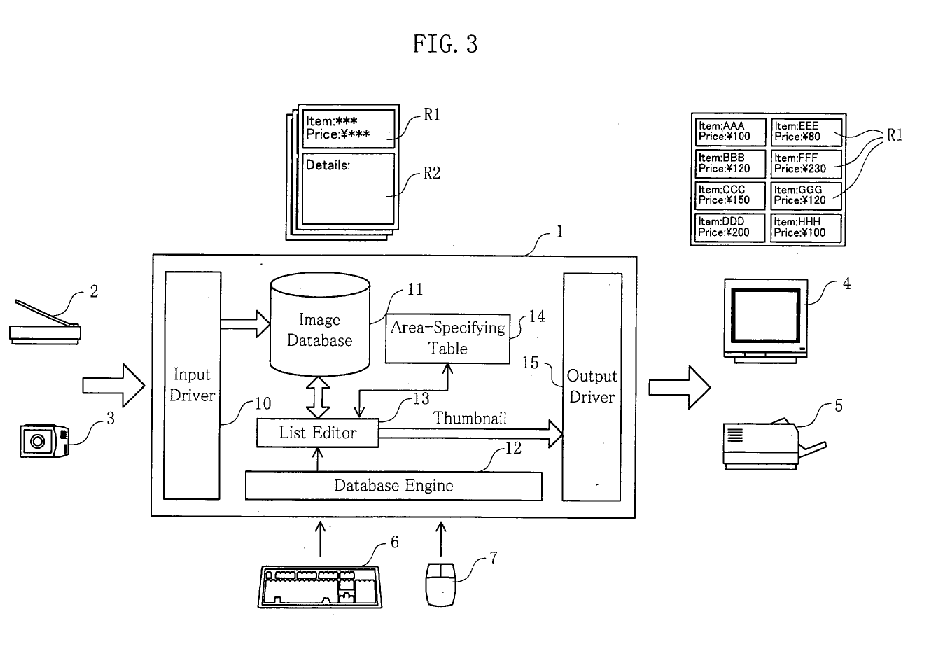

Referring now to FIGS. 3 and 4, an image data processor according to a second embodiment of the present invention will be described below.

The image data processor of the second embodiment functions in the same manner as the image data processor of the first embodiment, except that the extracted image data from the database 11 by the list editor 13 is “thumbnailed” or reduced in size (S12). The other steps shown in FIG. 4 are the same as the counterparts shown in FIG. 2. Specifically, Step 11 of the second embodiment corresponds to Step 1, Step 13 to Step 2, and Step 14 to Step 3.

In accordance with the second embodiment, as seen from the comparison between FIG. 1A and FIG. 3, it is possible to display a greater number of rectangular areas of the extracted data on the monitor 4 than in the above-described first embodiment.

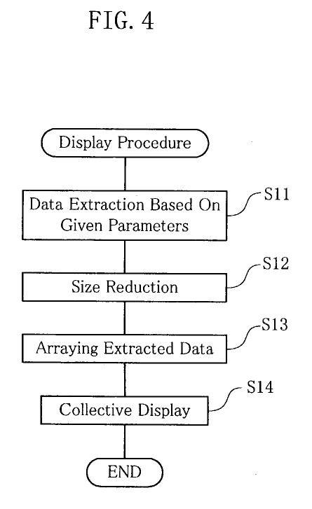

FIG. 5 shows an image data processor according to a third embodiment of the present invention.

The third embodiment differs from the first and the second embodiments in that the data extraction parameters can be set differently for the respective fliers so that information in different sections will be extracted from the fliers. The setting of parameters may be performed manually by the user or automatically by the processor 1. The data extraction parameters are stored in a storage 24 in a manner such that each set of parameters relevant to a flier is associated with the image data (stored in the database 11) of the flier. A particular set of data extraction parameters may be associated with one of the keys of the keyboard 6 for recursive use. In this case, the user can easily set the same extraction parameters for different fliers simply by pressing the particular key (shortcut key).

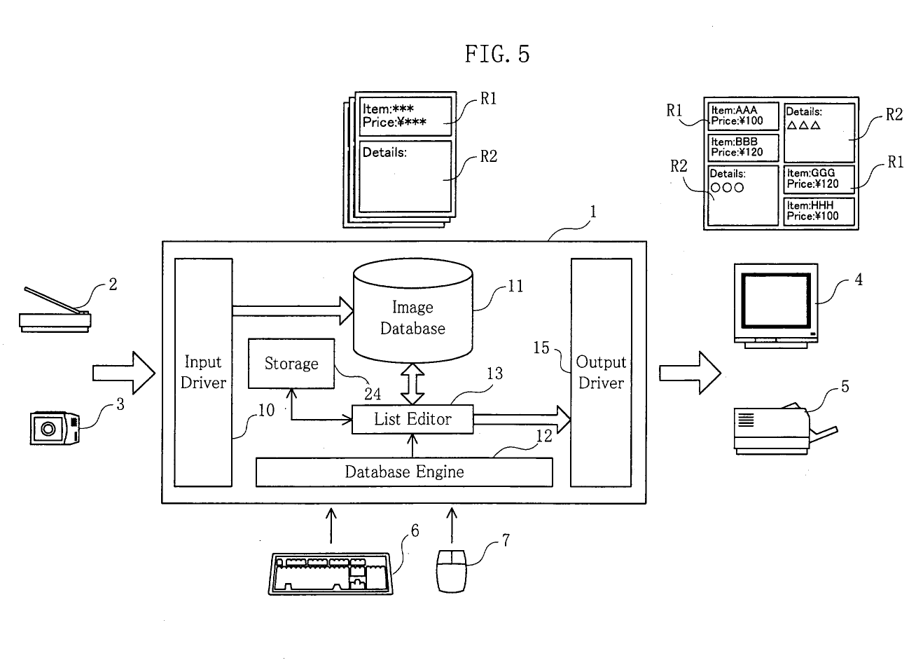

With the above embodiment, when the user selects the image data search mode, the list editor 13 reads out image data from the database 11 and extracts the individually specified section for each flier in accordance with the format data (i.e., the data extraction parameters) stored in the storage 24 (S21 in FIG. 6). Then, the list editor 13 makes thumbnail data of the extracted data (S22) and organizes it for effecting an arrayed display on the monitor 4 (S23).

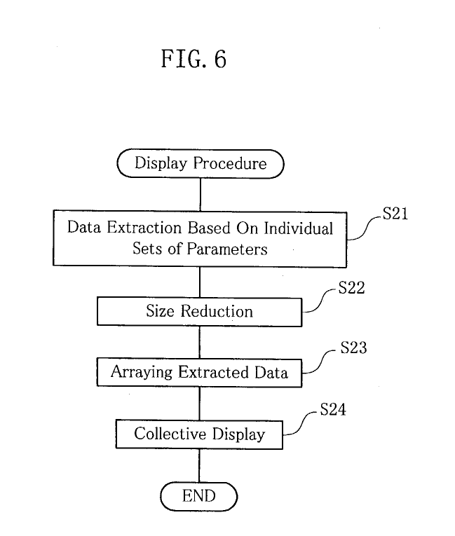

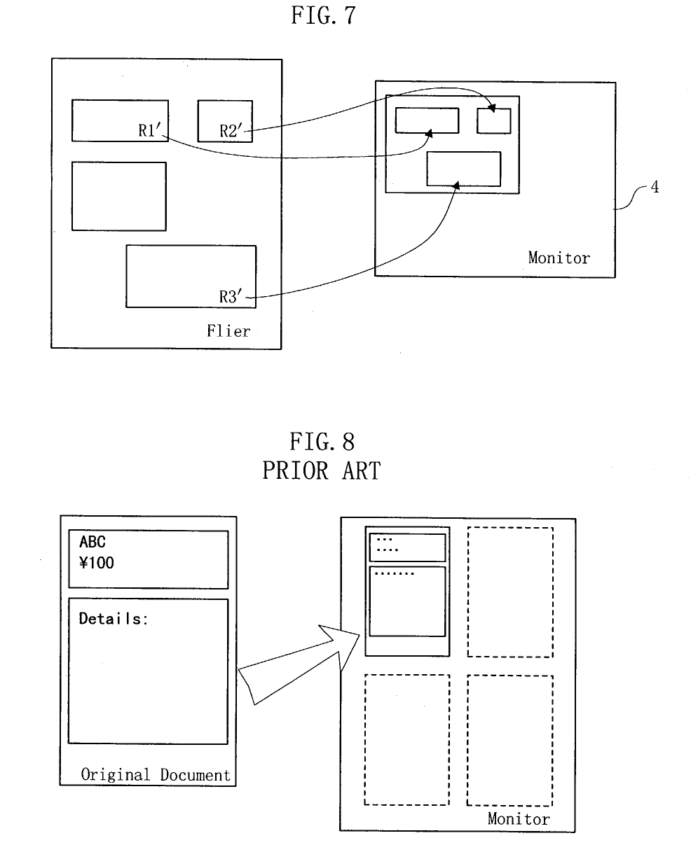

In the embodiments described above, one section is extracted from each flier. However, as shown in FIG. 7, more than one section (R1′, R2′, R3′) may be extracted from one flier, and these sections are collectively displayed on the monitor 4.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A data processor comprising:
a database including individual pieces of image data;
a storage that stores area-specifying data to specify part of each individual piece of the image data; and
an editor that extracts partial image data from each individual piece of the image data in accordance with the area-specifying data.

2. The data processor according to claim 1, wherein the area-specifying data includes area-specifying parameters that are common for all the individual pieces of the image data.

3. The data processor according to claim 1, wherein the area-specifying data includes a plurality of area-specifying parameter sets each corresponding to one of the individual pieces of the image data.

4. The data processor according to claim 1, wherein the area-specifying data comprises a parameter for specifying a point of an extraction area and a parameter for specifying a size of the extraction area.

5. The data processor according to claim 1, wherein the area-specifying data is produced by the editor based on the image data included in the database.

6. The data processor according to claim 5, wherein the editor is provided with a recognition function for a particular color, and wherein the image data included in the database comprises information on the particular color.

7. The data processor according to claim 5, wherein the editor is provided with a recognition function for a particular configuration, and wherein the image data included in the database comprises information on the particular configuration.

8. The data processor according to claim 5, wherein the editor is provided with a recognition function for a particular letter, and wherein the image data included in the database comprises information on the particular letter.

9. The data processor according to claim 1, wherein the area-specifying data for the image data comprises area-specifying parameters for specifying at least two different areas.

10. The data processor according to claim 1, wherein the editor subjects the extracted partial image data to size reduction.

11. The data processor according to claim 1, wherein the area-specifying data stored in the storage is recursive for a newly-input individual piece of image data.

12. A computer program for executing the procedures of:
storing area-specifying data to specify part of image data stored in a database; and
extracting partial image data from the image data in the database based on the area-specifying data.
